(19) United States
(12) Patent Application Publication
(10) Pub. No.: US 2026/0014937 A1
(43) Pub. Date: Jan. 15, 2026

(54) Trunk Cargo Stabilizer with Adaptive Sizing Mechanism

(71) Applicant: Santo J. Coglitore, Charlotte, NC (US)

(72) Inventor: Santo J. Coglitore, Charlotte, NC (US)

(21) Appl. No.: 18/768,866

(22) Filed: Jul. 10, 2024

(51) Int. Cl. B60R 9/06; B60R 11/00

(52) U.S. Cl. CPC B60R 9/06; B60R 2011/0036

(57) ABSTRACT

In some aspects, the present invention discloses an adjustable trunk organizer designed to securely accommodate varying cargo sizes in vehicle trunks. The organizer features a base portion and multiple interconnected side panels, with at least two opposing panels being adjustable in length. An integrated adjustment mechanism allows for expansion or contraction of these panels to fit different load sizes snugly. A key feature is the locking mechanism, which secures the adjustable panels in the desired position, preventing unwanted cargo movement during transit. This locking mechanism can include manual options like latches or thumb screws, or an automatic slide lock for effortless securing. Additional features include a removable divider for creating separate compartments, foldability for compact storage, and a non-slip base. This versatile organizer enhances cargo security, maximizes space utilization, and improves overall trunk organization efficiency.

### FIELD OF THE DISCLOSURE

The present invention relates to vehicle storage accessories, specifically to adjustable and foldable trunk organizers. More particularly, it pertains to a versatile container with expandable sides that can be secured in various positions, designed to accommodate and secure diverse cargo sizes in vehicle trunks while offering compact storage when not in use.

### BACKGROUND OF THE INVENTION

The storage and organization of items within vehicle trunks have long been a challenge for drivers and passengers alike. As vehicles have evolved over the decades, so too has the need for efficient and adaptable storage solutions. The problem of loose items sliding, tipping, or becoming damaged during transit has persisted, leading to a continuous effort to develop improved storage systems.

Historically, vehicle storage solutions began as simple boxes or crates that could be placed in the trunk. These rudimentary solutions, while functional, lacked versatility and often failed to maximize the available space efficiently. As consumer needs grew more sophisticated, so did the designs of trunk organizers.

The prior art in this field demonstrates a progression towards more adaptable and user-friendly solutions. For instance, US20010020631A1 introduced a storage system with a base and hingedly attached walls that could be folded flat for compact storage. This represented a significant step forward in terms of convenience and space utilization when the organizer was not in use. However, this design still lacked the ability to adjust to varying load sizes while in use.

Another notable development came with U.S. Pat. No. 7,121,601B2, which presented an integrated storage system that could extend from a vertical panel of the vehicle. While this invention offered the advantage of being flush with the vehicle when not in use, it did not address the need for adjustability to accommodate different cargo sizes securely.

U.S. Pat. No. 9,016,494B1 introduced an expandable item carrying device with compactable longitudinal sides and bottom wall. This design began to address the need for adaptability, allowing the device to expand or contract along its longitudinal axis. However, it did not provide a comprehensive solution for securing items of various sizes within a vehicle trunk.

U.S. Pat. No. 5,234,116A brought forth a collapsible and expandable framework for holding packages or bags. This invention allowed for linear extension or contraction to accommodate different-sized compartments. While this design offered more flexibility, it still lacked a secure locking mechanism to prevent unwanted movement during transit.

U.S. Pat. No. 6,053,553A represents a more advanced attempt at variable subdivision of a storage compartment. It introduced articulated partitions and a locking device between the displaceable partition and the floor of the storage compartment. This design offered improved functionality in terms of spatial division and securing the organizer to the trunk floor. However, it did not provide the ease of adjustment and automatic locking features that would be ideal for quick and efficient use.

Despite these advancements, the prior art collectively falls short in several key areas. None of the cited inventions fully address the need for a storage solution that can quickly and easily adjust to fit various load sizes while also securely locking in place without manual intervention. The ability to expand or contract to snugly fit different amounts of cargo, combined with an automatic locking mechanism, represents a significant gap in the existing technology.

Furthermore, the prior art does not adequately solve the problem of creating a device that is both highly adaptable when in use and compact when stored. Many existing solutions either sacrifice adjustability for compactness or vice versa, leaving room for improvement in balancing these two crucial aspects.

In light of these shortcomings in the prior art, there remains a clear need for an innovative trunk organizer that combines adjustability, security, ease of use, and compact storage. Such a device would represent a significant advancement in vehicle storage technology, addressing the long-standing challenges of efficiently organizing and securing diverse cargo in vehicle trunks.

### SUMMARY OF THE INVENTION

The following summary provides an overview of some of the key inventive features of the novel adjustable trunk organizer with self-locking mechanism. This summary is not an extensive overview of the invention and is not intended to identify all key or critical elements of the invention or to delineate the scope of the invention. Its sole purpose is to present some concepts of the invention in a simplified form as a prelude to the more detailed description that is presented later.

In some aspects thereof, the present invention is an adjustable trunk organizer comprising a base portion and multiple interconnected side panels, where at least two opposing panels are adjustable in length to accommodate varying cargo sizes.

One exemplary aspect of the invention is the integrated locking mechanism that secures the adjustable side panels in the desired position after adjustment, preventing unwanted movement of cargo during vehicle transit.

In another aspect, the invention also incorporates an automatic slide lock mechanism that allows the adjustable side panels to lock into place without requiring manual intervention by the user, enhancing ease of use and efficiency.

In various aspects, the adjustable trunk organizer provides additional features such as a removable divider for creating separate compartments, foldability for compact storage when not in use, and a non-slip base to prevent sliding within the vehicle trunk.

The invention addresses the long-standing challenges of efficiently organizing and securing diverse cargo in vehicle trunks, offering a versatile solution that combines adaptability, security, and user-friendly operation. The invention's ability to adjust to different cargo sizes while maintaining a secure hold represents a significant advancement in vehicle storage technology, potentially improving the driving experience and cargo management for a wide range of users.

### BRIEF DESCRIPTION OF THE DRAWINGS

The accompanying drawings, which are incorporated in and constitute a part of this specification, illustrate embodiments of the invention and, together with the description, serve to explain the principles of the invention. The drawings are not necessarily to scale, emphasis instead being placed upon illustrating the principles of the invention. In the drawings:

FIG. 1 is an extended view of the adjustable trunk organizer according to one aspect.

FIG. 2 is an retracted view of the adjustable trunk organizer according to another aspect.

FIG. 3 is a collapsed view of the trunk organizer.

FIG. 4 is a side view of the adjustable trunk organizer.

FIG. 5 is an adjustable trunk organizer having a divider.

### DETAILED DESCRIPTION OF THE INVENTION

The following detailed description refers to the accompanying drawings, which illustrate specific embodiments of the invention. Other embodiments having different structures and operations do not depart from the scope of the present invention. The same reference numbers may be used in the drawings and the following description to refer to the same or like parts.

As used herein, the terms “comprising,” “including,” “containing,” “characterized by,” and grammatical equivalents thereof are inclusive or open-ended and do not exclude additional, unrecited elements or method steps, unless otherwise stated. Other than in the operating examples, or where otherwise indicated, all numbers expressing measurements, dimensions, and so forth used in the specification and claims are to be understood as being modified in all instances by the term “about,” meaning within a reasonable range of the indicated value. The terms “a” and “an” refer to one or more of the elements described, whereas the term “plurality” refers to two or more of the elements described, unless the context clearly indicates otherwise.

The adjustable trunk organizer with self-locking mechanism described herein provides novel solutions for efficient and customizable cargo organization in vehicle trunks. The invention incorporates adjustable side panels, an integrated locking mechanism, and an automatic slide lock, enabling adaptable cargo containment, increased security, and convenient use. The following detailed description, along with the accompanying drawings, provides a comprehensive understanding of the various embodiments and aspects of the invention.

This adjustable trunk organizer addresses the challenges of accommodating varying cargo sizes while ensuring secure transport. It offers a versatile solution that combines adaptability with user-friendly operation, potentially improving cargo management for a wide range of users across different vehicle types. The invention's ability to adjust to different load sizes while maintaining a secure hold represents a significant advancement in vehicle storage technology.

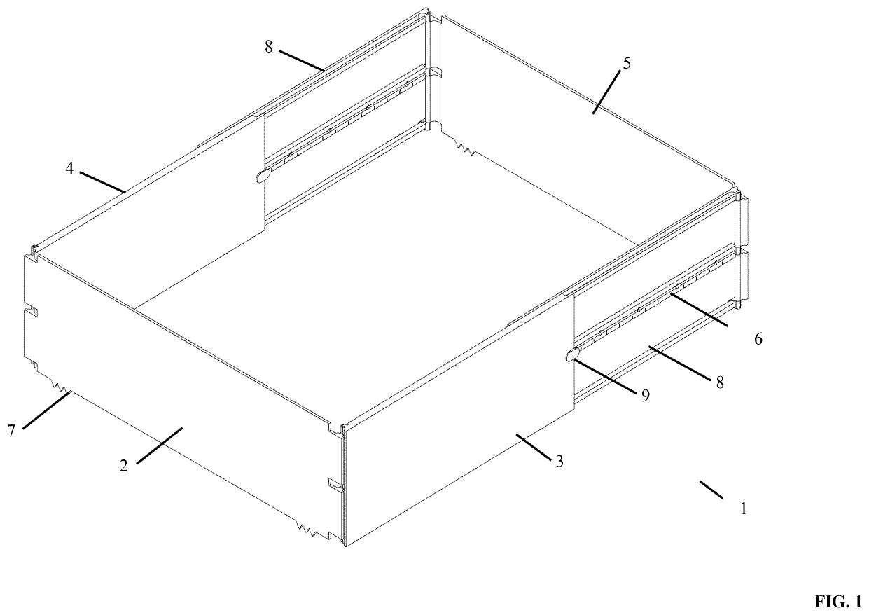

The embodiment of FIG. 1 illustrates an extended view of the adjustable trunk organizer (1) according to one aspect of the invention. This innovative design showcases the key components that allow for versatile and secure cargo organization within a vehicle trunk.

In this exemplary embodiment, the adjustable trunk organizer (1) is comprised of four interconnected side panels (2, 3, 4, 5) that extend upwardly from a base portion (7). The base portion (7) is designed to rest flat on the vehicle trunk floor, providing a stable foundation for the entire structure. It may incorporate a non-slip surface or material to enhance stability during transit. In some aspects, the bottom surface of the base portion (7) may be designed with a jagged edge pattern.

Without limitation, the side panels 2 and 5 form the fixed ends of the organizer, while side panels 3 and 4 are adjustable. These adjustable panels feature extension panels (8) that can extend outward or retract inward, allowing the organizer to accommodate various cargo sizes. The extension panels (8) slide about or within the main structure of side panels 3 and 4, ensuring a seamless adjustment process. This jagged edge pattern may consists of a series of small, angled protrusions or teeth that run along the a portion of the perimeter and on the bottom surface of the base portion (7). These jagged edges are strategically designed to increase friction between the organizer and the vehicle trunk floor, significantly enhancing the grip of the entire unit.

Further, the adjustment mechanism (6) is integrated into the design of the adjustable side panels (3, 4). This mechanism facilitates the extension or retraction of the extension panels (8), allowing users to easily modify the organizer's dimensions to fit their specific cargo needs.

Another aspect of the organizer is the locking mechanism (9), which works in conjunction with the adjustment mechanism (6). This locking mechanism secures the adjustable side panels (3, 4) in the desired position after adjustment, ensuring that the organizer maintains its shape and size during transit. The locking mechanism (9) may incorporate various designs such as latches, thumb screws, or an innovative automatic slide lock for enhanced user convenience.

As an alternative to the previously described locking mechanisms, an exemplary embodiment of the adjustable trunk organizer utilizes a friction-based system for securing the adjustable side panels. This may leverage calibrated friction between the sliding panels to achieve both ease of adjustment and stability during use. In this embodiment, the sliding interfaces of the panels may be engineered with precise surface treatments or textures that create an optimal level of resistance. This resistance is sufficient to hold the panels firmly in place when cargo is snugly packed, preventing unwanted movement during transit, yet still allows for easy manual adjustment by the user.

The exemplary friction-based system eliminates the need for manual or automatic locking mechanisms, simplifying the design and potentially reducing manufacturing costs. Users can expand or contract the sides to accommodate different cargo sizes without engaging or disengaging any locks.

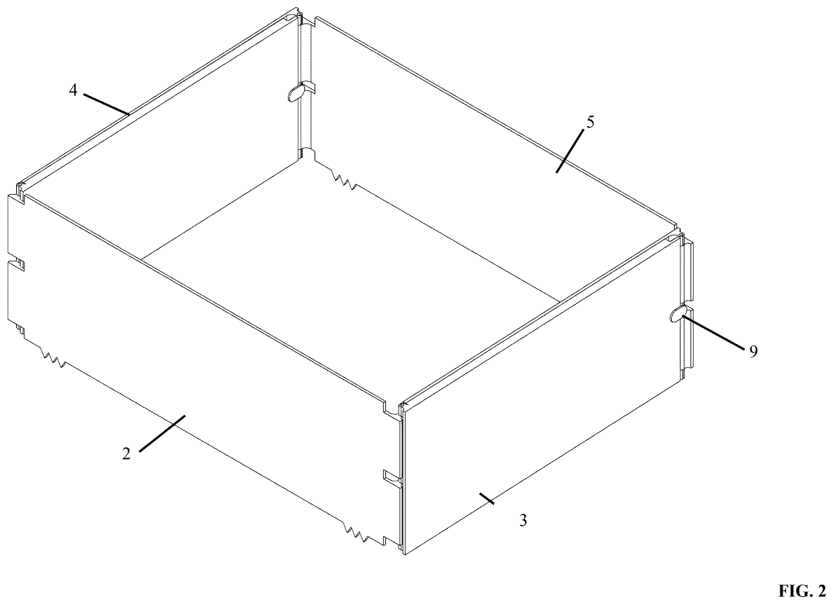

On the other hand, FIG. 2 illustrates a retracted view of the adjustable trunk organizer (1), showcasing its compact configuration when not fully extended. This view demonstrates the versatility and space-saving design of the invention, highlighting its ability to adapt to different storage needs and trunk spaces.

In this retracted state, the four interconnected side panels (2, 3, 4, 5) are shown in their most compact arrangement. Side panels 2 and 5, which form the fixed ends of the organizer, remain in their original positions. However, the adjustable side panels 3 and 4 are depicted in their fully retracted state, with their extension panels pulled inward to create the smallest possible footprint for the organizer.

The interconnected nature of the side panels (2, 3, 4, 5) is clearly visible in this view, demonstrating how the structure maintains its integrity even when fully retracted. This interconnected design ensures that the organizer remains stable and functional regardless of its adjusted size.

Even in the retracted state, the locking mechanism is shown engaged, securing the adjustable side panels (3, 4) in their compact position. This illustrates the importance of the locking mechanism in maintaining the organizer's desired configuration, whether fully extended, partially extended, or fully retracted.

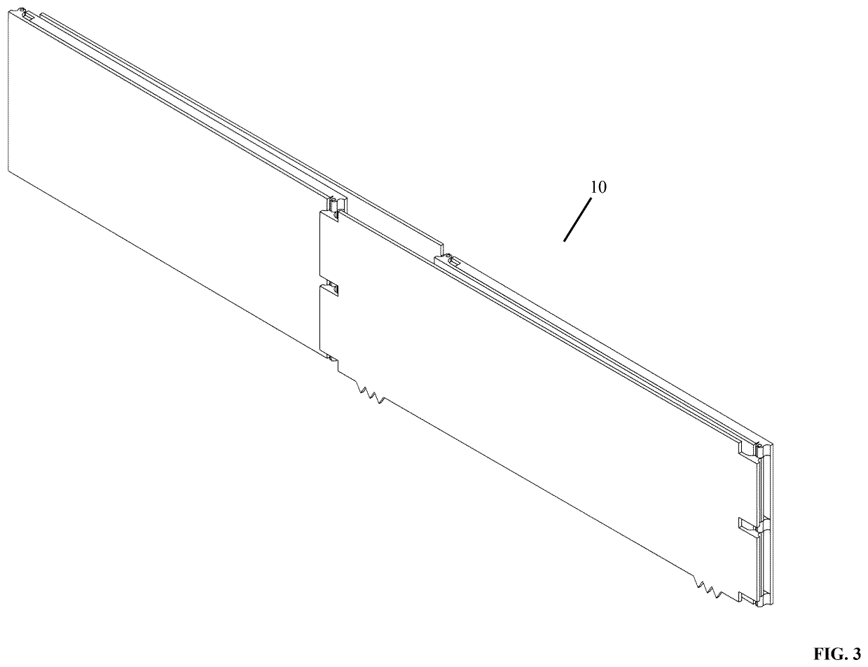

Further, shown on the FIG. 3 is a collapsed view of the trunk organizer, illustrating its ultimate space-saving configuration when not in use. This view highlights the organizer's remarkable versatility and its ability to be stored efficiently in the vehicle trunk or other storage areas.

In this collapsed state, the trunk organizer (10) is shown completely folded down, with all its components compactly arranged. The interconnected side panels, including the adjustable panels with their extension mechanisms, are folded inward and lie flat.

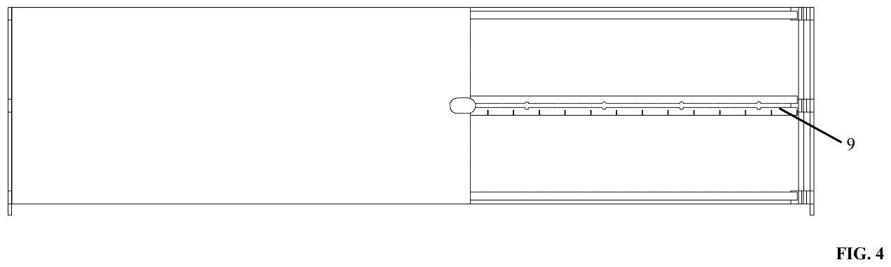

On the other hand, FIG. 4 presents a side view of the adjustable trunk organizer, highlighting the locking mechanism (9). This perspective showcases the profile of the organizer and illustrates how the locking mechanism integrates with the side panels to secure their position.

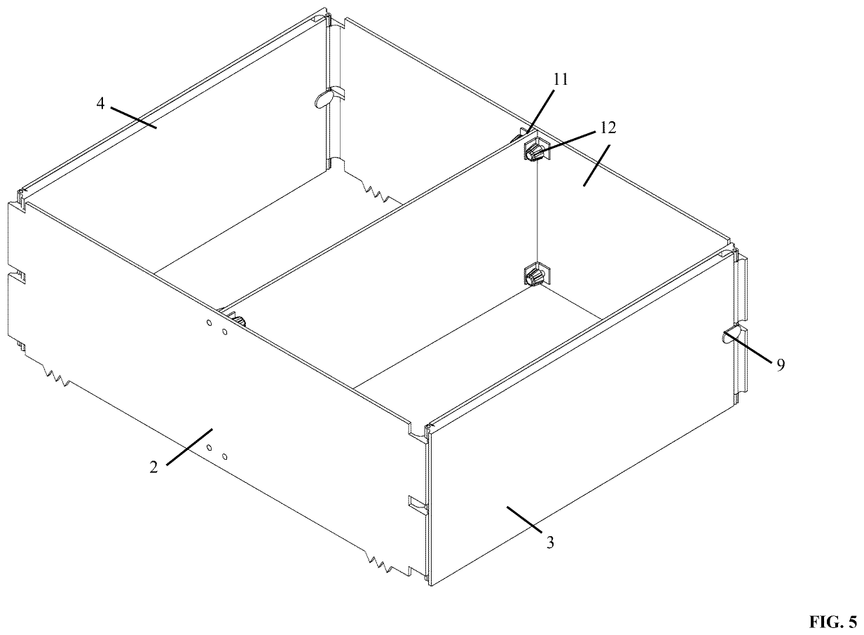

The embodiment of FIG. 5 is an adjustable trunk organizer having a divider. In this non-limiting aspect, the partition (11) is depicted extending from side panel 2 across the interior of the organizer to side panel 5. This partition effectively divides the organizer's internal space into two separate compartments, allowing for more organized and efficient use of the storage area. The partition (11) is designed to be removable and adjustable, enabling users to customize the interior layout of the organizer to suit their specific cargo needs.

An aspect illustrated in this figure is the partition locking mechanism (12). This mechanism is crucial for securing the partition (11) in place once it has been positioned. The partition locking mechanism (12) ensures that the partition remains stable during transit, preventing it from shifting or collapsing under the weight of the cargo or due to vehicle movement. The presence of the partition (11) and its locking mechanism (12) significantly enhances the organizer's utility. It allows users to separate different types of items, prevent them from mixing or damaging each other during transit, and create customized storage solutions for various scenarios. For instance, one compartment could be used for groceries while the other holds sports equipment, or the partition could separate fragile items from heavier, more robust cargo.

Various aspects of the invention illustrate a cargo organization system strategically formed within the adjustable trunk organizer. This cargo organization system is designed to efficiently arrange and secure items of different sizes during transport. In one embodiment, the cargo organization system comprises adjustable side panels that can expand or contract to snugly fit around the cargo. These adjustable panels serve to prevent items from shifting or tipping during transit, ensuring safe transportation. In another embodiment, the cargo organization system includes a removable partition that can be positioned at various points within the organizer. This partition acts as a divider, allowing for the creation of separate compartments to organize different types of items. The incorporation of the cargo organization system, whether through adjustable panels or removable partitions, ensures a secure and customizable storage solution for various cargo needs.

In one exemplary embodiment, the adjustable trunk organizer may be used by grocery shoppers seeking to secure their purchases during transport. After a shopping trip, the user can place the organizer in their vehicle trunk and adjust the side panels to accommodate the grocery bags. By using the locking mechanism, the user can secure the panels in place, creating a snug fit around the groceries. The adjustable nature of the organizer helps to prevent bags from tipping over or items from rolling around during the drive home. As the journey progresses, the secured organizer keeps everything in place, ensuring a mess-free arrival. This adaptable organization can be incorporated into the user's regular shopping routine to help prevent damage to purchases and make unloading easier.

In another exemplary embodiment, the adjustable trunk organizer may be used by individuals who frequently transport a mix of personal and professional items. The user can place the organizer in their trunk and use the removable partition to create separate compartments for different categories of items. For instance, one side could hold work-related materials like laptops or documents, while the other side contains personal items such as gym bags or groceries. The user can adjust the size of each compartment as needed by moving the partition and adjusting the side panels. The locking mechanism ensures that all items remain secure and separate during transit. This versatile organization system allows the user to efficiently manage diverse cargo needs in a single trip, making it a convenient and effective way to maintain order in their vehicle trunk for various daily activities.

### BEST MODE FOR CARRYING OUT THE INVENTION

The preferred best mode of carrying out the invention involves the use of an adjustable trunk organizer with self-locking side panels. To begin, the user places the folded organizer in the vehicle trunk and unfolds it to its basic shape. The user then assesses the size and nature of the cargo to be organized and begins to adjust the side panels accordingly.

The user extends or retracts the adjustable side panels to create a space that snugly fits the cargo. This is done by manipulating the adjustment mechanism, which allows for smooth expansion or contraction of the panels. Once the desired size is achieved, the user engages the locking mechanism to secure the panels in place. If using the automatic slide lock feature, this locking occurs automatically as the panels are adjusted.

If the cargo consists of different types of items that need to be separated, the user can insert the removable partition. The partition is placed in the desired position within the organizer and secured using the partition locking mechanism. This creates separate compartments within the organizer for more efficient cargo management.

The user then loads the cargo into the adjusted organizer. The snug fit provided by the adjusted panels and the optional partition helps prevent items from shifting or tipping during transit. The non-slip base of the organizer, which may feature a jagged edge pattern, helps keep the entire unit stable within the trunk.

Once the journey is complete, the user can easily remove the cargo from the organizer. If the organizer is no longer needed, it can be collapsed by disengaging the locking mechanisms, folding the side panels inward, and then folding the entire unit flat for compact storage. This versatile process can be repeated for various cargo needs, providing a flexible and efficient solution for trunk organization.

### BENEFITS OF THE INVENTION

The trunk organizer presented in this invention offers numerous advantages over existing solutions, addressing key issues in vehicle cargo management. Its enhanced adaptability, facilitated by adjustable sides, allows the container to accommodate a wide range of cargo sizes, from small grocery loads to larger items, thus maximizing trunk space utilization. This flexibility significantly improves security by enabling the organizer to fit snugly around cargo of various sizes, substantially reducing the risk of items shifting, tipping, or becoming damaged during transit. The user-friendly operation, highlighted by the automatic slide lock mechanism, enables quick and effortless adjustment without the need for manual locking, enhancing convenience for users of all ages and abilities.

When not in use, the foldable design allows for compact storage, preserving valuable trunk space for other purposes. This space efficiency is complemented by the organizer's versatility, featuring an optional divider that provides further customization and allows users to organize multiple types of items simultaneously. Constructed from robust materials, the organizer offers long-lasting performance under various conditions, ensuring durability. Its universal design makes it suitable for use in different vehicle types and models, increasing its market potential and overall utility.

From a practical standpoint, the invention proves cost-effective by preventing damage to transported items, potentially saving users money in the long run. Additionally, the secure containment of items reduces driver stress about potential cargo movement during travel, contributing to a more relaxed driving experience. The quick adjustment and automatic locking features streamline the process of loading and unloading the vehicle, saving valuable time for users in their daily activities. Overall, this trunk organizer represents a significant advancement in vehicle storage technology, offering a comprehensive solution to the long-standing challenges of efficiently organizing and securing diverse cargo in vehicle trunks.

### INDUSTRIAL APPLICATION

The industrial applications of this versatile trunk organizer extend beyond personal vehicle use, offering potential benefits across various sectors. In the automotive industry, car manufacturers could integrate this design as a standard feature in new vehicles, enhancing their appeal to consumers seeking practical storage solutions. Delivery services and logistics companies could utilize this invention to optimize cargo organization in their fleet vehicles, potentially improving efficiency and reducing product damage during transport. Rental car companies could offer these organizers as value-added accessories, improving customer satisfaction. Additionally, the design principles could be adapted for use in other transportation modes, such as boats or recreational vehicles, expanding its market reach and utility across different mobility sectors.

What is claimed is:

1. An adjustable trunk organizer comprising:
a base portion configured to rest on a vehicle trunk floor;
a plurality of interconnected side panels extending upwardly from the base portion, wherein at least two opposing side panels are adjustable in length;
an adjustment mechanism coupled to the adjustable side panels, allowing expansion or contraction of the side panels to accommodate varying cargo sizes;
a locking mechanism integrated with the adjustment mechanism, configured to secure the adjustable side panels in a selected position; and
wherein the locking mechanism is operable to maintain the selected position of the adjustable side panels during vehicle transit, thereby preventing unwanted movement of cargo within the organizer.

2. The adjustable trunk organizer of claim 1, wherein the locking mechanism comprises one or more elements selected from the group consisting of latches, thumb screws, friction locks, and slide locks, configured to secure the adjustable side panels in the desired position after adjustment.

3. The adjustable trunk organizer of claim 1, wherein the locking mechanism further comprises an automatic slide lock mechanism that allows the adjustable side panels to lock into place after being adjusted without requiring manual locking by the user.

4. The adjustable trunk organizer of claim 1, further comprising a removable divider configured to create separate compartments within the organizer.

5. The adjustable trunk organizer of claim 1, wherein the base portion and side panels are foldable for compact storage when not in use.

6. The adjustable trunk organizer of claim 1, further comprising a grip material or design on the bottom surface of the base portion to prevent sliding within the vehicle trunk.

7. The adjustable trunk organizer of claim 1, wherein the base portion comprises a jagged edge pattern to enhance grip on the vehicle trunk floor.

8. A method of organizing cargo in a vehicle trunk, comprising:
providing an adjustable trunk organizer having a base portion and a plurality of interconnected side panels extending upwardly from the base portion, wherein at least two opposing side panels are adjustable in length;
placing the adjustable trunk organizer on a vehicle trunk floor;
adjusting the length of the adjustable side panels to accommodate a specific cargo size;
engaging a locking mechanism to secure the adjustable side panels in a selected position; and
loading cargo into the adjusted trunk organizer, wherein the secured side panels prevent unwanted movement of the cargo during vehicle transit.

9. The method of claim 8, wherein engaging the locking mechanism comprises manipulating one or more elements selected from the group consisting of latches, thumb screws, friction locks, and slide locks to secure the adjustable side panels in the desired position after adjustment.

10. The method of claim 8, wherein engaging the locking mechanism comprises allowing an automatic slide lock mechanism to lock the adjustable side panels into place after adjustment without requiring manual locking by the user.

11. The method of claim 8, further comprising inserting a removable divider into the trunk organizer to create separate compartments within the organizer.

12. The method of claim 8, further comprising folding the base portion and side panels for compact storage when the trunk organizer is not in use.

13. The method of claim 8, wherein placing the adjustable trunk organizer on the vehicle trunk floor comprises positioning the organizer such that a grip material or design on the bottom surface of the base portion prevents sliding within the vehicle trunk.

14. The method of claim 13, wherein the base portion comprises a jagged edge pattern, and wherein placing the adjustable trunk organizer on the vehicle trunk floor includes positioning the organizer such that the jagged edge pattern enhances grip on the vehicle trunk floor.
